(19) United States
(12) Patent Application Publication
(10) Pub. No.: US 2016/0059430 A1
(43) Pub. Date: Mar. 3, 2016

(54) Knife sheath apparatus and method

(71) Applicant: Justin Coffey Justin Coffey, Lakewood, WA (US)

(72) Inventor: Justin Coffey Justin Coffey, Lakewood, WA (US)

(21) Appl. No.: 14/756,343

(22) Filed: Aug. 29, 2015

Related U.S. Application Data
(60) Provisional application No. 62/070,596, filed on Aug. 30, 2014.

(51) Int. Cl. B26B 29/02

(52) U.S. Cl. CPC B26B 29/025

(57) ABSTRACT

A knife sheath for protecting the blade of a knife, the knife sheath comprising a front panel formed to engage and releasably interlock, with a rear panel to form an expandable interior chamber disposed to receive the blade of a knife through an entry slot formed in the knife sheath. For this purpose, the front panel includes first and second rows of integrally formed spaced-apart front panel sidewalls, and the rear panel includes first and second rows of integrally formed spaced-apart rear panel sidewalls. The sidewalls are spaced so that the first row of rear panel sidewalls are disposed to be received between the second row of front panel sidewalls, and the second row of rear panel sidewalls are disposed to be received between the first row of front panel sidewalls to releasably interlock the sidewalls of the front panel with the sidewalls of the rear panel.

This application claims the benefit of U.S. Provisional Application No. 62/070,596

### BACKGROUND

This invention relates generally to knives, and more particularly to protective covers, sheaths and holsters for carrying and transporting knives.

Knife sheaths employed for storing and carrying knives are common and well known. Examples include U.S. Pat. No. 6,634,503 issued in 2003 which include two sections that snap together. U.S. Pat. No. 5,568,888 issued in 1996 illustrating a one piece sheath having a liner. U.S. Pat. No. 5,315,761 issued in 1994 showing a sheath that includes a retentional mechanism, and U.S. Pat. No. 5,146,684 issued in 1992 constructed as one piece with a slot arranged to receive a belt or the like.

However, none of the prior art sheaths are designed to adapt to knives having blades of various sizes, and wherein the user can easily secure the sheath to the users outerwear for safe transport thereof.

Accordingly, a need remains for a knife sheath that can expand to accommodate blades of various sizes in a safe environment, and that allow the user to easily secure the same to outerwear.

### SUMMARY

One object of the present invention is to increase the safety in transporting a knife.

A second object is to reduce the costs associated with manufacturing sheaths for knives.

Another object is improve the ease with which a knife can be stowed.

Yet another object is simplify the procedure to secure and transport knives having blades of various sizes.

A further object is to allow a user to employ common materials to secure the sheath to the users outerwear.

Still another object is to reduce the time and effort to retrieve a knife that has been stowed.

The invention is a knife sheath for protecting the blade of a knife. In one embodiment, a planar front panel is formed to engage and releasably interlock, interconnect and mesh with a similarly shaped planar rear panel to form an expandable interior chamber. The interior chamber is disposed to receive the blade of a knife through a knife receiving entry slot that is formed by portions of the front panel and the rear panel. In this configuration, the knife entry slot defines two opposing ends: a first slot end and an opposing second slot end.

For this purpose, the front panel comprises a front panel interior surface defined by a front panel outside perimeter that extends from the first slot end, of the knife receiving slot, to the opposing second slot end of the knife receiving slot. Further, the front panel defines a front panel interior surface centrally disposed between a first row of integrally formed spaced-apart front panel sidewalls, and a second row of integrally formed spaced-apart front panel sidewalls, wherein the first and second row of front panel sidewalls define opposing portions of the front panel outside perimeter of the front panel, wherein the front panel interior surface extends from an front panel entry slot edge, between the first and second rows of front panel sidewalls.

Similarly, the rear panel defines a rear panel interior surface centrally disposed between a first row of integrally formed spaced-apart rear panel sidewalls, and a second row of integrally formed spaced-apart rear panel sidewalls, wherein the first and second row of rear panel sidewalls define a portion of the rear panel outside perimeter of the rear panel. The rear panel interior surface extends from a rear panel entry slot edge between the first and second rows of rear panel sidewalls.

In addition, the first row of rear panel sidewalls are disposed to be received between the second row of front panel sidewalls, and the second row of rear panel sidewalls are disposed to be received between the first row of front panel sidewalls to releasably interlock the sidewalls of the front panel with the sidewalls of the rear panel. With this configuration, the entry slot is disposed between the front panel entry slot edge and the rear panel entry slot edge.

Further, in another embodiment, the front panel of the knife sheath comprises a first row of integrally formed spaced-apart front panel inner sidewalls disposed adjacent the first row of front panel sidewalls in staggered arrangement. Similarly a second row of integrally formed spaced-apart front panel inner sidewalls are disposed adjacent the second row of front panel sidewalls in staggered arrangement.

Likewise, the rear panel further comprises a first row of integrally formed spaced-apart rear panel inner sidewalls disposed adjacent the first row of rear panel sidewalls in staggered arrangement, and a second row of integrally formed spaced-apart rear panel inner sidewalls disposed adjacent the second row of rear panel sidewalls in staggered arrangement.

With this construction, when the front and rear panels are in the interlocked position, the first row of front panel inner sidewalls interlock with the second row of rear panel inner sidewalls, and the second row of front panel inner sidewalls interlock with the first row of rear panel inner sidewalls.

The foregoing and other objects, features, and advantages of this invention will become more readily apparent from the following detailed description of a preferred embodiment which proceeds with reference to the accompanying drawings, wherein the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE DRAWINGS

FIG. 1 is a top view of a knife sheath.

FIG. 2 is a side elevation view of a Knife sheath.

FIG. 3. is an end view illustrating the front panel drain hole.

FIG. 4. is an end view showing the knife receiving slot.

FIG. 5 is a perspective view showing the front panel engaged and interlocked with a rear panel to form a knife receiving entry slot.

FIG. 6 is a perspective view showing a front panel engaged and interlocked with a rear panel to form a knife sheath having a strap retention slot.

FIG. 7 is a perspective view illustrating a knife sheath broken apart with the front panel disposed above a rear panel, with the interior surfaces thereof exposed.

FIG. 8 is an enlarged perspective view illustrating a knife inserted into the entry slot of a knife sheath with the front and rear panels in the interlocked position.

FIG. 9 is an enlarged perspective view of a knife sheath illustrating the entry slot and the interior chamber thereof.

FIG. 10 is an enlarged perspective view illustrating a knife sheath with the front and rear panels in a partially separated and expanded position.

FIG. 11 is an enlarged partial perspective view illustrating the rear panel drain opening and retention slot formed in the slot extension of the rear panel.

FIG. 12 is a perspective view illustrating a knife sheath received and secured within a sheath holster wherein a knife blade is being protected by the knife sheath.

### DETAILED DESCRIPTION OF PREFERRED EMBODIMENT

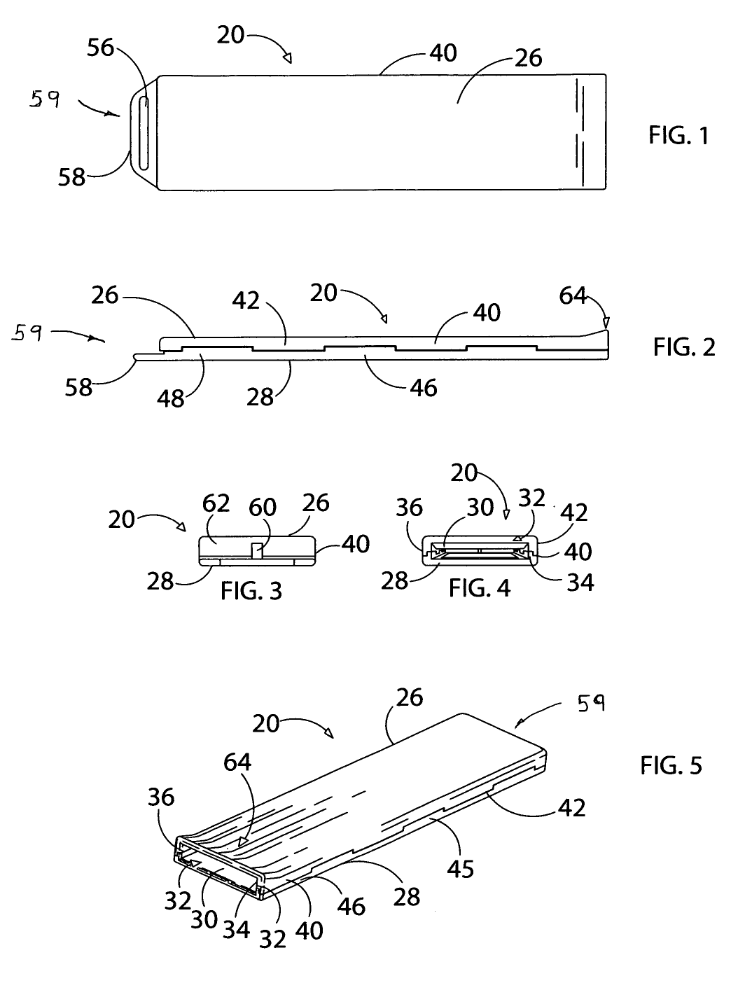

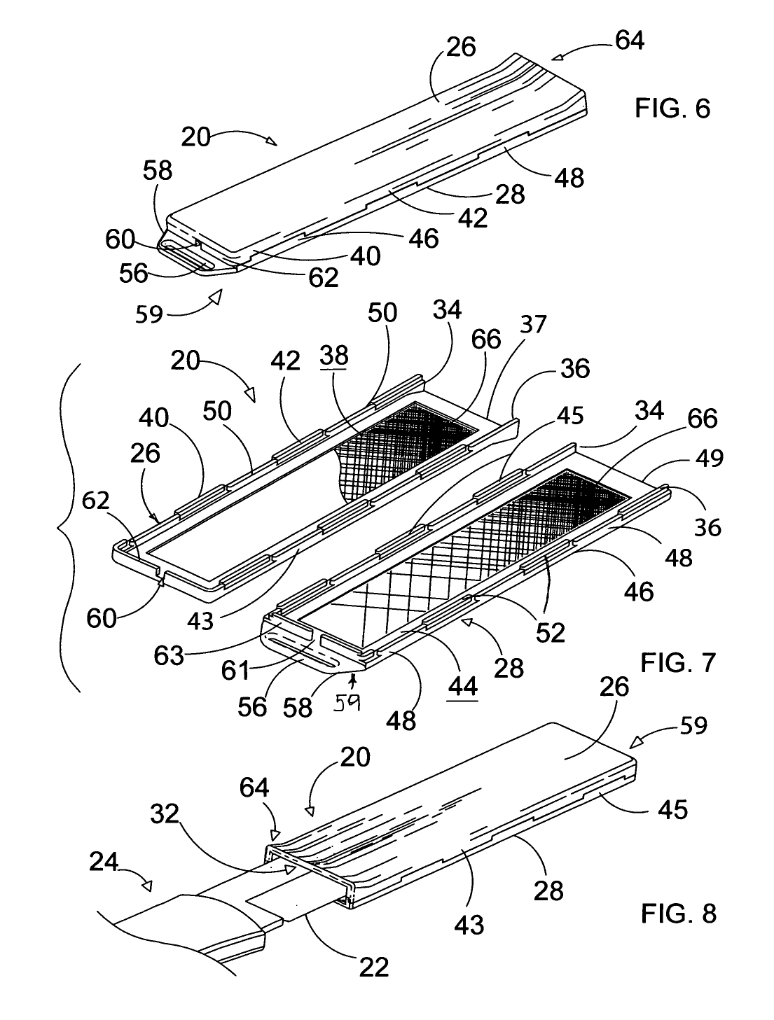

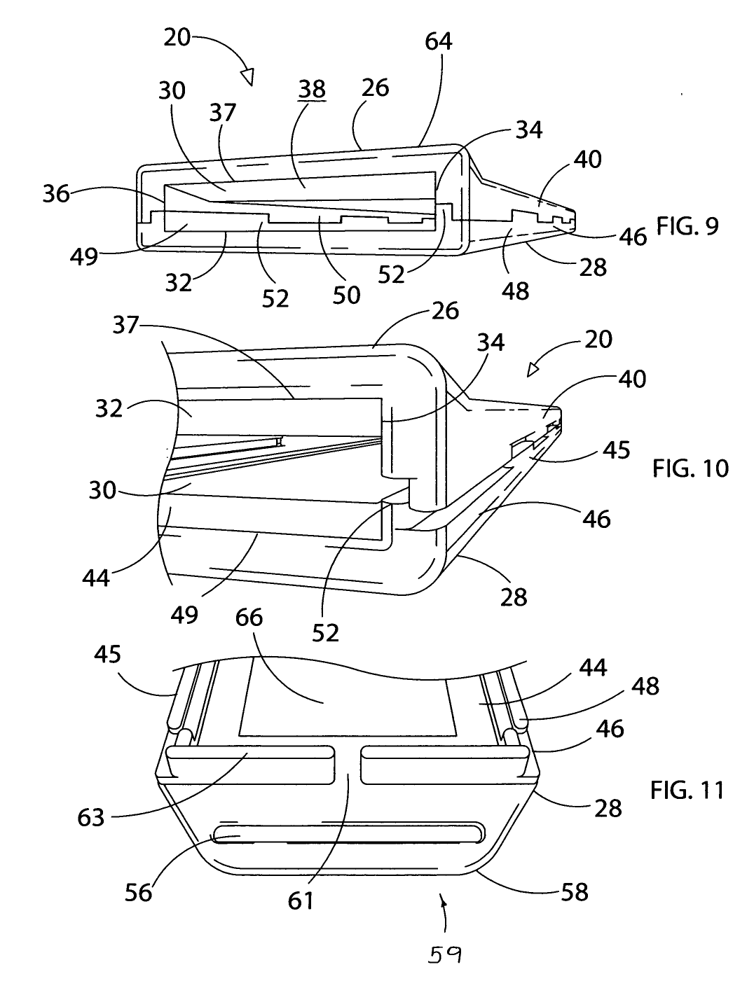

FIGS. 1 through 12 illustrate a knife sheath 20 for protecting the blade 22 of a knife 24. In one embodiment, a planar front panel 26 is formed to engage and releasably interlock, interconnect and mesh with a similarly shaped planar rear panel 28 to form an expandable interior chamber 30. The interior chamber 30 is disposed to receive the blade 22 of a knife 24 through a knife receiving entry slot 32 that is formed between portions of the front panel 26 and the rear panel 28. In this configuration, the knife entry slot 32 defines two opposing ends—a first slot end 34 and an opposing second slot end 36.

For this purpose, the front panel 26 defines a front panel interior surface 38 centrally disposed between a first row of integrally formed spaced-apart front panel sidewalls 42, and a second row of integrally formed spaced-apart front panel sidewalls 43, wherein the first and second row of front panel sidewalls 42-43 define opposing portions of the front panel outside perimeter 40 of the front panel 26. The front panel interior surface 38 extends from an front panel entry slot edge 37, between the first and second rows of front panel sidewalls 42-43.

Similarly, the rear panel defines a rear panel interior surface 44 centrally disposed between a first row of integrally formed spaced-apart rear panel sidewalls 45, and a second row of integrally formed spaced-apart rear panel sidewalls 48, wherein the first and second row of rear panel sidewalls 45 and 48 define a portion of the rear panel outside perimeter 46 of the rear panel 28. The rear panel interior surface 44 extends from a rear panel entry slot edge 49 between the first and second rows of rear panel sidewalls 45 and 48.

As will be discussed more fully below, the first row of rear panel sidewalls 45 are disposed to be received between the second row of front panel sidewalls 43, and the second row of rear panel sidewalls 48 are disposed to be received between the first row of front panel sidewalls 42 to releasably interlock the sidewalls of the front panel 26 with the sidewalls of the rear panel 28. With this configuration, the entry slot 32 is disposed between the front panel entry slot edge 37 and the rear panel entry slot edge 49.

In addition, as illustrated in FIG. 7, another embodiment, the front panel 26 of the knife sheath 20 further comprises a first row of integrally formed spaced-apart front panel inner sidewalls 50 disposed adjacent the first row of front panel sidewalls 42 in staggered arrangement, and a second row of integrally formed spaced-apart front panel inner sidewalls 52 are disposed adjacent the second row of front panel sidewalls 53 in staggered arrangement. Likewise, the rear panel further comprises a first row of integrally formed spaced-apart rear panel inner sidewalls 54 disposed adjacent the first row of rear panel sidewalls 45 in staggered arrangement, and a second row of integrally formed spaced-apart rear panel inner sidewalls 52 disposed adjacent the second row of rear panel sidewalls 48 in staggered arrangement.

With this configuration, when the front and rear panels 26 and 28 are in the interlocked position, the first row of front panel inner sidewalls 50 interlock with the second row of rear panel inner sidewalls 52, and the second row of front panel inner sidewalls 53 interlock with the first row of rear panel inner sidewalls 54. It should be understood that the term—interlock—is used only to indicated that sidewalls of the front panel 26, and the rear panel 28, fit together in a specific way, to restrict relative side movement between the panels.

Considering now in more detail the components from which a knife sheath 20 is constructed, FIG. 7 illustrates a preferred embodiment, where both inner sidewalls and outer sidewalls are provided for both the front and rear panels 26 and 28. In this way, an added measure of stability is produced to maintain the front panel 26 in relation to the rear panel 28 while still allowing the knife sheath 20 to expand according to the thickness of the blade 22 of a knife 24. In addition, to facilitate a tight and secure fit between the front panel 26 and rear panel 28, the outer sidewalls are staggered in relation to the inner sidewalls for both the front panel 26 and rear panel 28. Moreover, in the preferred embodiment, the front panel 26 comprises three sidewalls in each first and second row of front panel sidewalls 42-43, the sidewalls being spaced apart to receive a similar number of rear panel sidewalls as formed in the first and second rows of rear panel sidewalls 45 and 48, i.e., the first row of rear panel sidewalls 45 includes three spaced apart sidewalls, and the second row of rear panel sidewalls 48 include three spaced apart sidewalls.

Similarly, each front and rear panel 26 and 28 include three spaced-apart inner sidewalls in each first and second row. In the same way as above, the first and second rows of inner sidewalls of the front panel 26 are in staggered relation to the first and second rows of the rear panel 28.

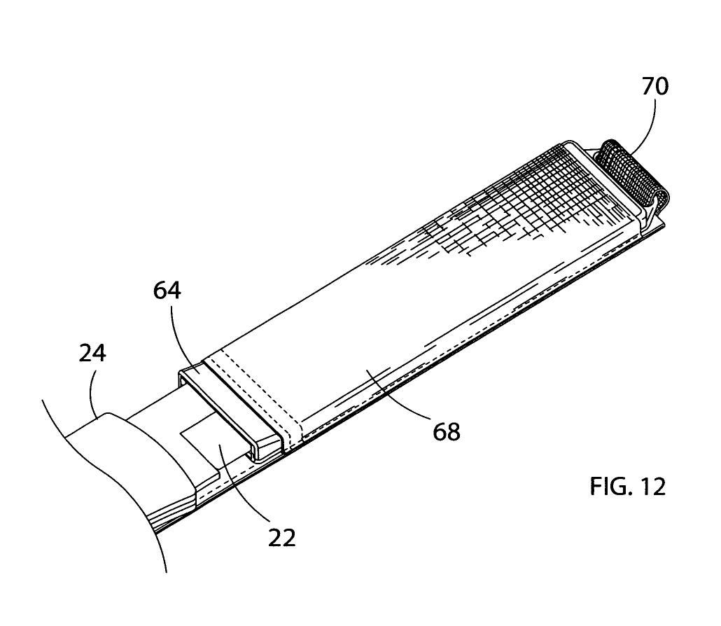

Directing attention to FIG. 12, a common geometric configuration of a knife sheath 20 includes a substantially rectangular front and rear panel 26-28. In this way, the knife sheath 20 can easily fit into a sheath holster 68, as illustrated. A sheath holster 68 is preferably made from material suitable for sewing, and for attachment to the user's body. To help facilitate the securing of the knife sheath 20 within the sheath holster 68, a holster strap 70, extends from the sheath holster 68.

For this purpose, the rear panel 28, is formed with a slot extension 58 that defines a strap retention slot 56 sized to receive the holster strap 70. Accordingly, the sheath holster 68 maintains the front and rear panel, 26 and 28, in close interlocked relationship, whereas the holster strap 70 maintains the knife sheath 20 within the sheath holster 68. Importantly, the slot extension 58 is integrally formed with the rear panel 28. Also, it should be noted that, in a preferred embodiment, a front panel 26 is formed to include a slight flared end 64 to help position a knife 24 within a knife sheath 20.

Considering now other features of a knife sleeve 20, FIGS. 7 and 11 illustrate a front panel 26 that further comprises a front panel drain opening 60 centrally disposed between opposing front panel bottom sidewalls 62. likewise, the rear panel 28 further comprises a rear panel drain opening 61 centrally disposed between opposing rear panel bottom sidewalls 62. In this way, entry of any water within the knife sheath 20 will drain for the same.

Finally, again turning to FIG. 7, a fabric liner 66 is attached to the front panel interior surface 38, and to the rear panel interior surface 44. It should be noted that such a liner could be made from a variety of materials, and is only provided to help protect the blade 22 of a knife 24.

In the drawings and specifications there have been set forth preferred embodiments of the invention and although specific terms are employed, they are used in a generic and descriptive sense only and not for purposes of limitation.

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

What is claimed is:

1. A knife sheath for protecting the blade of a knife, the knife sheath comprising:
a front panel formed to engage and releasably interlock, with a rear panel to form an expandable interior chamber disposed to receive the blade of a knife through an entry slot formed in the knife sheath;
the front panel having a front panel interior surface centrally disposed between a first row of integrally formed spaced-apart front panel sidewalls, and a second row of integrally formed spaced-apart front panel sidewalls, wherein the first and second row of front panel sidewalls define opposing portions of the outside perimeter of the front panel, wherein the front panel interior surface extends from an front panel entry slot edge between the first and second rows of front panel sidewalls;
the rear panel having a rear panel interior surface centrally disposed between a first row of integrally formed spaced-apart rear panel sidewalls and a second row of integrally formed spaced-apart rear panel sidewalls, wherein the first and second row of rear panel sidewalls define a portion of the outside perimeter of the rear panel, wherein the rear panel interior surface extends from a rear panel entry slot edge between the first and second rows of rear panel sidewalls;
wherein the first row of rear panel sidewalls are disposed to be received between the second row of front panel sidewalls, and the second row of rear panel sidewalls are disposed to be received between the first row of front panel sidewalls to releasably interlock the sidewalls of the front panel with the sidewalls of the rear panel, and
wherein the entry slot is disposed between the front panel entry slot edge and the rear panel entry slot edge.

2. A knife sheath as recited in claim 1 wherein the front panel further comprises a first row of integrally formed spaced-apart inner sidewalls disposed adjacent the first row of front panel sidewalls in staggered arrangement, and a second row of integrally formed spaced-apart inner sidewalls disposed adjacent the second row of front panel sidewalls in staggered arrangement, and
the rear panel further comprises a first row of integrally formed spaced-apart inner sidewalls disposed adjacent the first row of rear panel sidewalls in staggered arrangement, and a second row of integrally formed spaced-apart inner sidewalls disposed adjacent the second row of rear panel sidewalls in staggered arrangement; and
wherein when the front and rear panel sidewalls are in the interlocked position, the first row of front panel inner sidewalls interlock with the second row of rear panel inner sidewalls, and the second row of front panel inner sidewalls interlock with the first row of rear panel inner sidewalls.

3. A knife sheath as recited in claim 2 wherein the rear panel incorporates a slot extension centrally disposed at a tail end of the rear panel that defines a strap retention slot for receiving a holster strap to secure the knife sheath to a sheath holster.

4. A knife sheath as recited in claim 3 wherein the front panel of the knife sheath defines a flared portion adjacent the entry slot to enlarge the entry slot of the knife sheath.

5. A knife sheath as recited in claim 3 wherein the front panel further comprises a front panel drain opening centrally disposed between opposing front panel bottom sidewalls, and the rear panel further comprises a rear panel drain opening centrally disposed between opposing rear panel bottom sidewalls.

6. A knife sheath as recited in claim 5 wherein the front panel interior surface further comprises a fabric liner, and the rear panel interior surface further comprises a fabric liner, wherein the fabric liners are disposed to protect the blade of a knife when the sidewalls of the knife sheath are interlocked.

7. A knife sheath as recited in claim 1 wherein the front panel further comprises a front panel drain opening centrally disposed between opposing front panel bottom sidewalls, and the rear panel further comprises a rear panel drain opening centrally disposed between opposing rear panel bottom sidewalls.

8. A knife sheath for protecting the blade of a knife, the knife sheath comprising:
a front panel formed to engage and releasably interlock, with a rear panel to form an expandable interior chamber disposed to receive the blade of a knife through an entry slot formed in the knife sheath;
the front panel having a front panel interior surface centrally disposed between a first row of integrally formed spaced-apart front panel sidewalls, and a second row of integrally formed spaced-apart front panel sidewalls, wherein the first and second row of front panel sidewalls define opposing portions of the outside perimeter of the front panel, wherein the front panel interior surface extends from an front panel entry slot edge between the first and second rows of front panel sidewalls;
the rear panel having a rear panel interior surface centrally disposed between a first row of integrally formed spaced-apart rear panel sidewalls and a second row of integrally formed spaced-apart rear panel sidewalls, wherein the first and second row of rear panel sidewalls define a portion of the outside perimeter of the rear panel, wherein the rear panel interior surface extends from a rear panel entry slot edge between the first and second rows of rear panel sidewalls;
wherein the first row of rear panel sidewalls are disposed to be received between the second row of front panel sidewalls, and the second row of rear panel sidewalls are disposed to be received between the first row of front panel sidewalls to releasably interlock the sidewalls of the front panel with the sidewalls of the rear panel, wherein the entry slot is disposed between the front panel entry slot edge and the rear panel entry slot edge;
wherein the front panel further comprises a first row of integrally formed spaced-apart inner sidewalls disposed adjacent the first row of front panel sidewalls in staggered arrangement, and a second row of integrally formed spaced-apart inner sidewalls disposed adjacent the second row of front panel sidewalls in staggered arrangement;
wherein the rear panel further comprises a first row of integrally formed spaced-apart inner sidewalls disposed adjacent the first row of rear panel sidewalls in staggered arrangement, and a second row of integrally formed spaced-apart inner sidewalls disposed adjacent the second row of rear panel sidewalls in staggered arrangement; and
wherein when the front and rear panel sidewalls are in the interlocked position, the first row of front panel inner sidewalls interlock with the second row of rear panel inner sidewalls, and the second row of front panel inner sidewalls interlock with the first row of rear panel inner sidewalls.

9. A knife sheath as recited in claim 8 wherein the rear panel incorporates a slot extension centrally disposed at a tail end of the rear panel that defines a strap retention slot for receiving a holster strap to secure the knife sheath to a sheath holster.

10. A knife sheath as recited in claim 8 wherein the front panel further comprises a front panel drain opening centrally disposed between opposing front panel bottom sidewalls, and the rear panel further comprises a rear panel drain opening centrally disposed between opposing rear panel bottom sidewalls.

11. A knife sheath as recited in claim 10 wherein the front panel interior surface further comprises a fabric liner, and the rear panel interior surface further comprises a fabric liner, wherein the fabric liners are disposed to protect the blade of a knife when the sidewalls of the knife sheath are interlocked.

12. A knife sheath as recited in claim 8 wherein the front panel interior surface further comprises a fabric liner, and the rear panel interior surface further comprises a fabric liner, wherein the fabric liners are disposed to protect the blade of a knife when the sidewalls of the knife sheath are interlocked.

13. A method for making a knife sheath for protecting the blade of a knife, the method comprising the steps:
forming a front panel to engage and releasably interlock, with a rear panel to provide an expandable interior chamber disposed to receive the blade of a knife through an entry slot formed in the knife sheath;
arranging the front panel to define a front panel interior surface centrally disposed between a first row of integrally formed spaced-apart front panel sidewalls, and a second row of integrally formed spaced-apart front panel sidewalls, wherein the first and second row of front panel sidewalls define opposing portions of the outside perimeter of the front panel, wherein the front panel interior surface extends from an front panel entry slot edge between the first and second rows of front panel sidewalls;
arranging the rear panel to define a rear panel interior surface centrally disposed between a first row of integrally formed spaced-apart rear panel sidewalls and a second row of integrally formed spaced-apart rear panel sidewalls, wherein the first and second row of rear panel sidewalls define a portion of the outside perimeter of the rear panel, wherein the rear panel interior surface extends from a rear panel entry slot edge between the first and second rows of rear panel sidewalls;
wherein the first row of rear panel sidewalls are disposed to be received between the second row of front panel sidewalls, and the second row of rear panel sidewalls are disposed to be received between the first row of front panel sidewalls to releasably interlock the sidewalls of the front panel with the sidewalls of the rear panel, and
wherein the entry slot is disposed between the front panel entry slot edge and the rear panel entry slot edge.

14. A method for making a knife sheath to protect the blade of a knife as recited in claim 13, the method further comprising the step:
integrally forming a first row of spaced-apart inner sidewalls disposed adjacent the first row of front panel sidewalls in staggered arrangement, and integrally forming a second row of spaced-apart inner sidewalls disposed adjacent [symbol]
